(19) United States
(12) Patent Application Publication
(10) Pub. No.: US 2010/0206122 A1
(43) Pub. Date: Aug. 19, 2010

(54) Accelerator pedal for a vehicle

(76) Inventor: Michael C. Seiltz, Goshen, IN (US)

Correspondence Address: CTS Corporation, 2375 Cabot Drive, Lisle, IL, 60532, US

(21) Appl. No.: 12/658,890

(22) Filed: Feb. 17, 2010

Related U.S. Application Data
(60) Provisional application No. 61/207,903, filed on Feb. 18, 2009.

(51) Int. Cl. G05G 1/44; G05G 1/30

(52) U.S. Cl. 74/512

(57) ABSTRACT

A pedal assembly for a vehicle includes a rotatable pedal arm coupled to a housing. In one embodiment, a flange protrudes outwardly from each side of a drum at the end of the pedal arm. A bushing is mounted to and surrounds each flange. The flanges with bushings thereon are supported on respective interior shoulders formed in opposed side walls of the housing. A sensor arm is coupled to the end of a shaft which extends through the drum. The sensor arm is responsive to movement of the pedal arm and cooperates with a sensor in the housing to generate an electrical signal representative of the position of the pedal arm.

### CROSS-REFERENCE TO RELATED APPLICATION

This application claims the benefit of the filing date and disclosure of U.S. Provisional Application Ser. No. 61/207,903 filed on Feb. 18, 2009 which is explicitly incorporated herein by reference as are all references cited therein.

### FIELD OF THE INVENTION

This invention relates to a pedal mechanism and, more specifically, to an accelerator pedal for a vehicle.

### BACKGROUND OF THE INVENTION

Automobile accelerator pedals have conventionally been linked to engine fuel subsystems by a cable, generally referred to as a Bowden cable. While accelerator pedal designs vary, the typical return spring and cable friction together create a common and accepted tactile response for automobile drivers. For example, friction between the Bowden cable and its protective sheath otherwise reduce the foot pressure required from the driver to hold a given throttle position. Likewise, friction prevents road bumps felt by the driver from immediately affecting throttle position.

The mechanical cable-driven throttle systems are being replaced with a more fully electronic, sensor-driven approach. With the fully electronic approach, the position of the accelerator pedal is read with a position sensor and a corresponding position signal is made available for throttle control. A sensor-based approach is especially compatible with electronic control systems in which accelerator pedal position is one of several variables used for engine control.

Although such drive-by-wire accelerator pedals have proven practical, there is a continued need to improve and lower the cost of such accelerator pedals.

### SUMMARY OF THE INVENTION

The present invention is directed to a pedal assembly which comprises a housing including opposed side walls and defines a cavity. Each of the side walls defines a shoulder or ledge. A pedal arm has a first end located in the cavity and a second end extending from the cavity. The first end is supported for rotation on the ledge defined on the side walls.

The first end of the pedal arm includes a drum which, in one embodiment, includes first and second flanges or collars which protrude outwardly from opposed first and second sides of the drum respectively. First and second bushings surround the first and second flanges respectively. The first flange with the first bushing is seated on the ledge on a first one of the opposed side walls and the second flange with the second bushing is seated on the ledge on the second one of the opposed side walls for supporting the pedal arm in the housing for rotational movement relative to the housing.

An axle or shaft extends through the drum and the flanges. The first side wall defines an aperture and the axle includes a first end which protrudes through the aperture. A sensor arm is coupled to the first end of the axle.

In one embodiment, the housing defines first and second cavities. The drum of the pedal arm extends into the first cavity and the sensor arm extends into the second cavity.

These and other objects, features and advantages will become more apparent in light of the text, drawings and claims.

### BRIEF DESCRIPTION OF THE DRAWINGS

In the accompanying drawings that form part of the specification, and in which like numerals are employed to designate like parts throughout the same:

FIG. 1 is a perspective view of an accelerator pedal assembly in accordance with the present invention;

FIG. 2 is an exploded perspective view of the accelerator pedal assembly of FIG. 1;

FIG. 3 is a perspective view of the pedal arm of the accelerator pedal assembly of FIG. 1;

FIG. 4 is a perspective view of the interior of the housing of the accelerator pedal assembly of FIG. 1;

FIG. 5 is a horizontal cross-sectional view of the accelerator pedal assembly of FIG. 1 showing additional details of the elements and interconnection between the pedal arm and the housing; and

FIG. 6 is an enlarged top plan view of the conductor film of the sensor assembly of the accelerator pedal assembly of FIG. 1.

### DETAILED DESCRIPTION OF THE EMBODIMENT

While this invention is susceptible to embodiment in many different forms, this specification and the accompanying drawings disclose only one embodiment as an example of the invention. The invention is not intended, however, to be limited to the embodiment so described, however. The scope of the invention is identified in the appended claims.

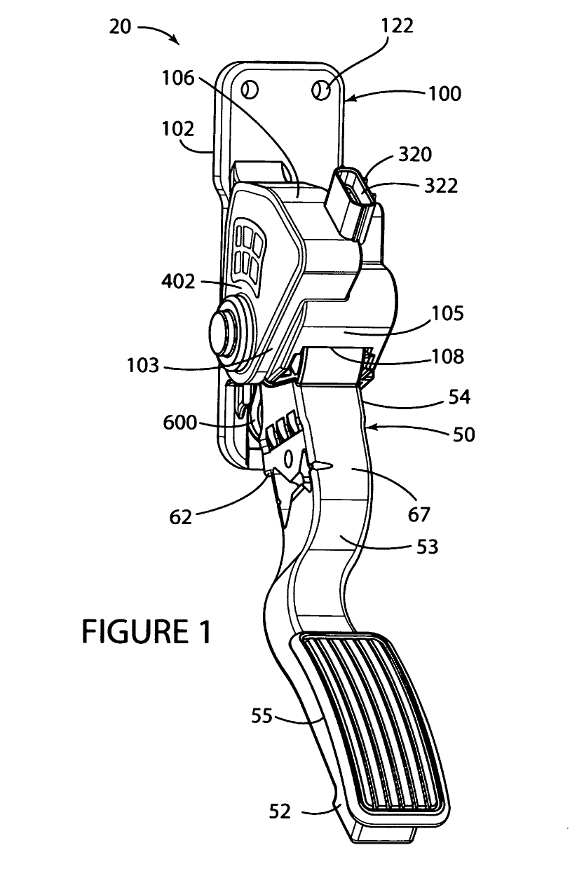

An accelerator pedal assembly 20 according to the present invention is shown in FIGS. 1-5 and generally is comprised of a pedal housing 100 and a pedal arm 50 that is rotatably mounted to the pedal housing 100. Housing 100 contains the components of the pedal assembly 20; is adapted for mounting to a firewall or floor of a vehicle (not shown); and can be formed from molded plastic.

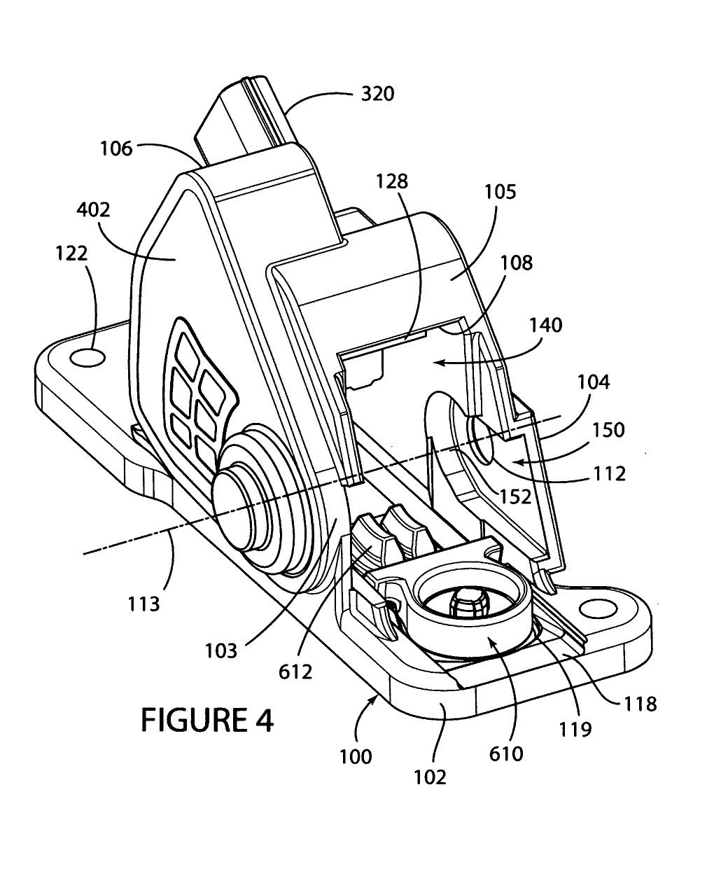

Pedal housing 100 has a bottom wall or base 102, side walls 103 and 104 (FIG. 4), and front and back walls 105 and 106 respectively. Side walls 103 and 104 are generally parallel and opposed to each other and extend generally vertically upwardly from the opposed side peripheral edges of the base 102.

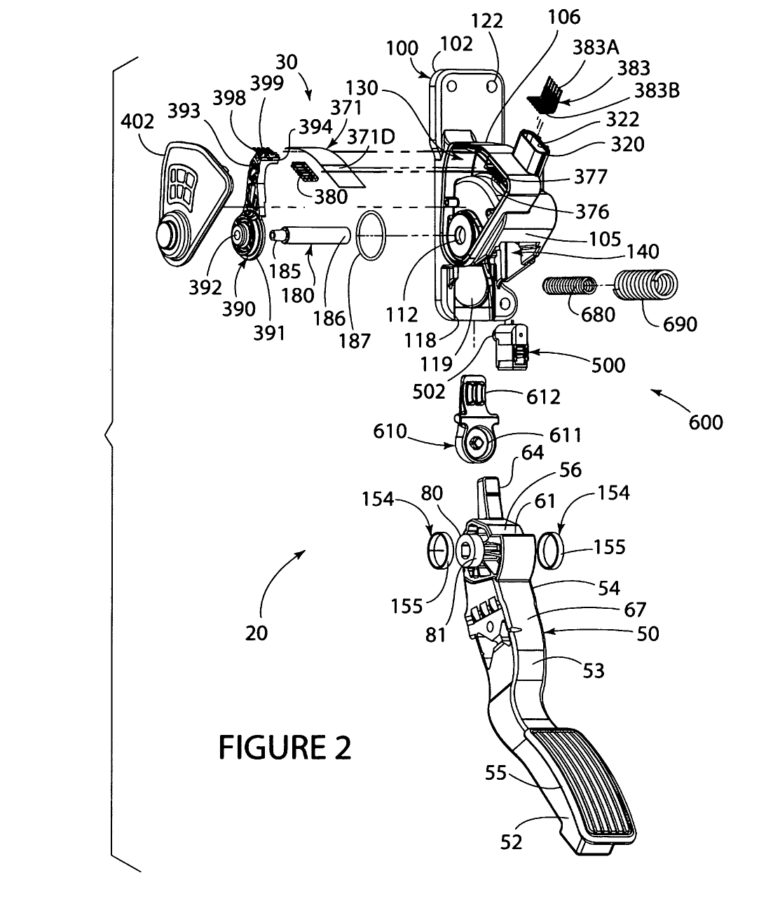

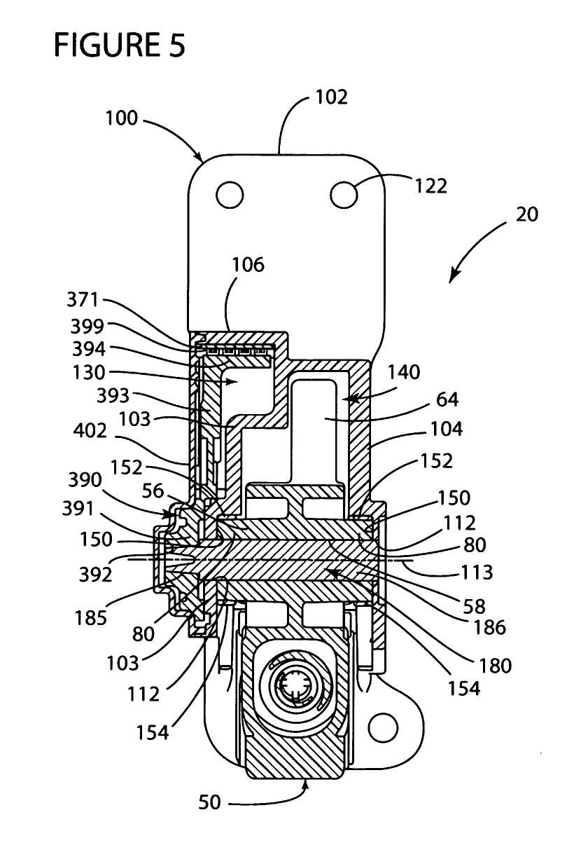

Several openings and cavities are defined in housing 100 including an interior sensor cavity 130 (FIGS. 2 and 5) and an interior pedal arm cavity 140 (FIGS. 2, 4, and 5) adjacent the cavity 130. Side wall 103 separates and isolates the cavities 130 and 140. A sensor assembly 30 (FIG. 2) is mounted in sensor cavity 130. Pedal arm 50 extends into, and is mounted for rotation in, pedal arm cavity 140. An aperture or cut-out 108 in the front housing wall 105 defines an opening for the pedal arm 50.

A generally circular aperture 112 (FIGS. 2, 4, and 5) extends through each of the side walls 103 and 104 in a co-linear relationship with pedal arm axis of rotation 113 (FIGS. 4 and 5).

A generally ear-shaped slot or recess 150 (FIGS. 4 and 5) is defined in the interior surface of each of the side walls 103 and 104 of housing 100. Each of recesses 150 is defined by an interior elongate shoulder or ledge or step 152 (FIG. 4) which extends generally normally outwardly from the interior face of each of the walls 103 and 104.

Several apertures 122 (FIG. 5) are defined in and extend through the base wall 102 and housing 100 is securable to a vehicle using fasteners such as bolts or screws (not shown) that pass through apertures 122. Pedal assembly 20 can mount to a firewall or pedal rack (not shown) by means of an adjustable or non-adjustable position pedal box rack (not shown) with minor changes to the housing 100.

Pedal arm housing 100 has a connector flange or housing 320 (FIGS. 1, 2 and 4) extending outwardly from the back housing wall 106 and defining a terminal cavity 322 therein. A shallow trough 118 (FIGS. 2 and 4) is defined in the base 102 of housing 100 adjacent the opening 108 in front wall 105. A circular recess or cavity 119 (FIGS. 2 and 4) is defined in trough 118.

As shown in FIGS. 1-3, elongated pedal arm 50 has a proxil end 54 emanating from pedal arm opening 108 (FIG. 1), a distal end 52, and an elongate portion 53 therebetween. The pedal arm 50 has a bottom surface 65 and a top surface 67. A footpad 55 is formed on the top surface of distal end 52 and is adapted to be depressed by the foot of a driver. Footpad 55 may be integral with the pedal arm 50 or may be articulating and rotating at its connection to distal end 52. Pedal arm 50 can be made from various suitable materials such as injection molded plastics or a metal.

Proxil end 54 of pedal arm 50 terminates in a rounded drum or hub 56. A generally circular barrel, boss, flange, or collar 80 is formed on and extends generally outwardly from each side of drum 56. Each flange 80 has a circumferential outer surface 81.

A ring-shaped metal bushing or bearing or insert 154 (FIG. 2) is mounted to and surrounds each of the flanges 80. Bushings 154 are press-fitted onto flanges 80. Bushing 154 has a circumferentially extending outer bearing surface 155. In one embodiment, the bushings 154 may be formed from plastic.

A generally D-shaped bore 58 (FIG. 5) is defined in and extends through the drum 56 and flanges 80. When pedal arm 50 is mounted in housing 100, bore 58 is contiguous/co-linear with the aperture 112 (FIG. 4) in each of the housing walls 103 and 104 and is coaxial with axis of rotation 113 (FIGS. 4 and 5). An elongated lever 64 (FIGS. 2, 3, and 5) extends from a lower portion of drum 56 and has a flat contact surface 66.

An elongated axle or shaft 180 (FIGS. 2 and 5) extends through the bore 58 in drum 56 and flanges 80. Axle or shaft 180 has opposed ends 185 and 186. End 186 is generally D-shaped. End 185 is generally cone-shaped.

Flanges 80 have a larger diameter than the axle or shaft 180 and the respective shoulders or ledges 152 have a surface area and width generally the same as the width of the respective flanges 80. The ends 185 and 186 protrude out of the flanges 80.

Pedal arm 50 is mounted in pedal arm cavity 140 (FIG. 5) in a relationship wherein the respective flanges 80 on the drum 56 extend into the cavity 150 in respective housing side walls 103 and 104 defined by the shoulder 152 in respective side walls 103 and 104 and, more specifically, into a relationship wherein the respective flanges 80 and, still more specifically, the bushings 154 on flanges 80, are supported and seated for rotation on and relative to the shoulder or ledge 152 defined in each of the respective housing side walls 103 and 104. The ends 185 and 186 of shaft 180 extend through the aperture 112 in respective housing side walls 103 and 104. Axle 180 can be formed from injection molded plastic or from a metal.

According to the invention, the use of a pedal arm 50 including a drum 56 with opposed flanges 80 adapted to be mounted and seated on respective ledges or shoulders 152 formed on the interior of housing side walls 103 and 104 advantageously allows the transfer of the load applied to the pedal arm 50 to be transferred from the shaft 180 to the housing walls 103 and 104 via the drum flanges 80 and housing wall ledges 152. The ability to transfer the load on pedal arm 50 away from the shaft 180 in turn then allows the shaft 180 to be of reduced diameter relative to the flanges 80 and allows the shaft 180 to be made of a less costly material than steel such as, for example, a plastic material.

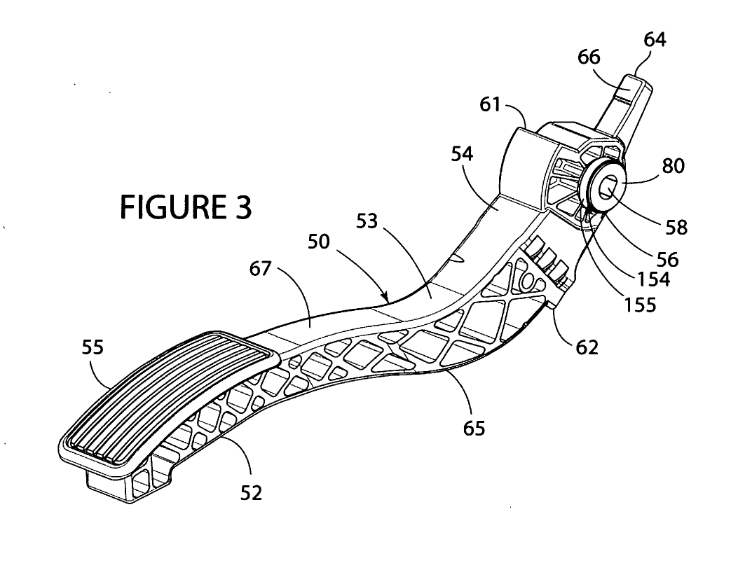

Referring back to FIGS. 2 and 3, a flat shoulder or idle stop 61 extends from an upper portion of drum 56 and a raised rib 62 extends from a bottom portion of pedal arm end 54. When pedal arm 50 is released, pedal arm 50 rotates until stop 61 contacts ridge or lip 128 (FIG. 4) of housing 100 to limit the backward movement of pedal arm 50. Pedal arm 50 can be depressed until it reaches another rotational limit at an open-throttle position where raised rib 62 of pedal arm 50 contacts shallow trough 118 (FIG. 4) to limit the forward movement of the pedal arm 50.

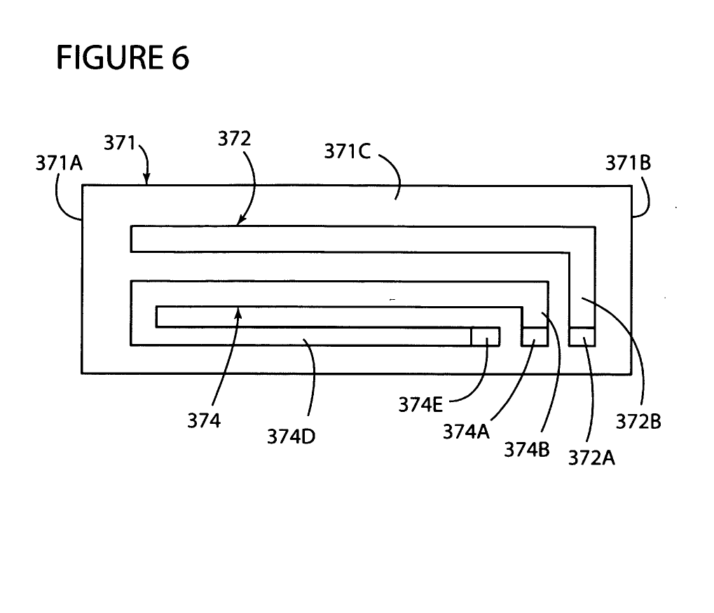

Details of sensor assembly 30 are shown in FIGS. 2 and 6. Sensor assembly 30 is mounted to pedal assembly 20 and is adapted to generate an electrical signal that can represent or transmit the position of pedal arm 50. Sensor assembly 30 may, as shown in FIGS. 2 and 6, comprise a contacting type sensor such as a variable resistor or potentiometer. In another embodiment, sensor assembly 30 may comprise a non-contacting type sensor that uses magnetic, capacitive or inductive technologies.

Sensor assembly 30 is mounted in sensor cavity 130 and includes a generally rectangularly shaped polyimide flexible film 371 with opposed transverse ends 371A and 371B (FIG. 6), a front surface 371C, and a back surface 371 D. Film 371 has a collector line or track 372 extending longitudinally along the length of the front surface 371C. A connector strip 372B extends from one end of the collector track 372. An active line or track 374 is also formed on, and extends longitudinally along the length of, the front surface 371C of film 371 in a relationship spaced from, and parallel to, the collector track 372. A first connector strip 374D extends from one end of the active track 374. A second connector strip 374B extends from an opposite end of the active track 374. The connector strip 372B of collector track 372 terminates in a voltage output pad 372A, the connector strip 374B of active track 374 terminates in a voltage input/supply pad 374A, and the other connector strip 374D of active track 374 terminates in a ground pad 374E. The pads 372A, 374A, and 374E are aligned in a spaced apart and co-linear relationship.

Film 371 is mounted in sensor cavity 130 against the interior surface of the back housing wall 106 (FIG. 5). An undulated or grooved terminal wall 376 (FIG. 2) partially extends into sensor cavity 130. A slot 377 is defined between the interior surface of the housing wall 106 and the terminal wall 376 (FIG. 2). Although not shown in the FIGURES, it is understood that the end 371B of film 371 is located in slot 377 in a relationship wherein the front surface 371C thereof faces the interior of the sensor cavity 130.

Terminals 383 (FIG. 2) are insert molded into connector shroud 320. Each of the terminals 383 has opposed ends 383A and 383B. Terminal end 383A is located in terminal cavity 322. Although not shown in any of the FIGURES, it is understood that the end 383B or respective terminals 383 extends into the slot 377 in sensor cavity 130 and into the respective grooves defined in terminal wall 376. Terminals 383 extend into connector shroud 320 and are adapted for connection to a wire harness (not shown) which connects with an engine control computer that controls an electric motor attached to a throttle plate mounted on the intake of the engine. In this manner, the pedal assembly 20 is able to control the throttle setting on the engine electronically or through a wire. Systems of this type are called drive-by-wire systems.

A metal pressure wedge 380 (FIG. 2) is pressure fit into the slot 377 defined in cavity 130 to make electrical connections between the collector track 372 and the end 383B of one of the terminals 383, and active track 374 and the end 383B of another of the terminals 383. Wedge 380 rests between the film back surface 371D and the housing wall 106. Wedge 380 forces connection pads 372A and 374A on the front surface 371C of the film 371 into electrical contact with the end 383B of respective terminals 383.

A rotor 390 (FIGS. 2 and 5) has a barrel or barrel-shaped proximal portion 391 defining a bore 392. An elongate arm 393 extends away from barrel 391 and terminates in a distal finger 394 which is oriented in a relationship generally normal to the end of the arm 393. The arm 393 extends into the sensor cavity 130. The barrel 391 of rotor 390 is affixed to the cone-shaped end 185 of shaft 180 in a relationship wherein the shaft end 185 extends through the bore 392 of barrel 391. Shaft end 185 can be heat staked, splayed or taper-locked to retain rotor 390 on shaft 180. A seal ring 187 (FIG. 2) is mounted and sandwiched between the interior face of barrel 391 and the outside face of housing wall 103.

Rotor 390 has a plurality of spaced apart and parallel metal contactors or wipers 398 attached to the finger 394. Each contactor 398 has a distal finger 399. During operation, as shaft 180 rotates, rotor 390 is rotated which causes the arm 393 to rotate, which causes the fingers 399 to move along the tracks 372 and tracks 374 on the film 371. As the fingers 399 move, a voltage applied to the terminals will change magnitude and generate an electrical output signal indicative of the position of pedal arm 50.

Additional details on the operation and construction of sensor assembly 30 are detailed in U.S. Pat. Nos. 5,416,295 and 6,474,191, the contents of which are specifically herein incorporated by reference in their entirety.

A sensor cover 402 is ultrasonically welded to the housing wall 103 to close and seal the sensor cavity 130.

A friction generating assembly 600 is shown in FIG. 2 and comprises at least a brake pad 610 and springs 680 and 690. Brake pad 610 includes a cup 611 adapted to receive the ends of springs 680 and 690 and a pair of spaced-apart and generally parallel contact fingers 612 at an opposite end adapted to inter-engage with a W-shaped braking surface (not shown) defined on the underside of the drum 56 when pedal arm 50 is rotated. Brake pad 610 is adapted to pivot over the recess 119 in base 102.

As pedal arm 50 is depressed (to accelerate) or released (to idle or decelerate), the force within compression springs 680 and 690 increases or decreases, respectively, and causes the brake pad 610 to pivot, which causes either increased or reduced friction contact with the drum surface. Additional details on the operation and construction of friction generating assembly 600 are detailed in U.S. Patent Publication No. 2007/0137400 entitled “Accelerator Pedal for a Vehicle”, the contents of which are specifically herein incorporated by reference in their entirety for related and supportive teachings.

A resistance mechanism or kickdown device 500 (FIG. 2) is also mounted in housing 100 and, more specifically, is suspended from the interior surface of the housing wall 105 and is adapted to provide an increased resistance to pedal depression at a certain point in the depression of pedal arm 50; provide resistive feedback to the foot of the pedal operator; and provide an indication that the pedal is near a maximum point of depression. The maximum point of pedal depression can correspond to a wide open engine throttle position or can be used to indicate a downshift point for an automatic transmission. Resistance mechanism 500 is activated in response to contact between the lever 64 on pedal arm 56 and the plunger 502 of resistance mechanism 500 in response to rotation of the drum 56 of pedal arm 50. Additional details on the operation and construction of resistance mechanism or kickdown device 500 are detailed in U.S. Pat. No. 6,418,813, entitled, “Kickdown Mechanism for a Pedal”, the contents of which are specifically herein incorporated by reference in their entirety.

Numerous variations and modifications of the embodiment described above may be effected without departing from the spirit and scope of the novel features of the invention. It is to be understood that no limitations with respect to the specific system illustrated herein are intended or should be inferred. It is, of course, intended to cover by the appended claims all such modifications as fall within the scope of the claims.

What is claimed is:

1. A pedal assembly comprising:
a housing including opposed side walls and defining a cavity, each of the side walls defining a ledge; and
a pedal arm having a first end located in the cavity and a second end extending from the cavity, the first end being supported for rotation on the ledge defined on the side walls, respectively.

2. The pedal assembly of claim 1 wherein the first end of the pedal arm includes a drum with first and second flanges protruding outwardly from opposed first and second sides of the drum respectively, and first and second bushings surrounding the first and second flanges respectively, the first flange with the first bushing being seated on the ledge on a first one of the opposed side walls and the second flange with the second bushing being seated on the ledge on a second one of the opposed side walls for supporting the pedal arm in the housing for rotational movement relative to the housing.

3. The pedal assembly of claim 2 wherein an axle extends through the drum and the flanges.

4. The pedal assembly of claim 3 wherein the first one of the opposed side walls defines an aperture and the axle includes a first end protruding through the aperture, the pedal assembly further comprising a sensor arm coupled to the first end of the axle.

5. A pedal assembly comprising:
a housing including a pair of opposed walls and defining a cavity, each of the walls including a shoulder defining a recess in each of the walls;
a pedal arm coupled to the housing, the pedal arm including a drum extending into the cavity, the drum of the pedal arm including respective flanges protruding outwardly from opposed sides thereof; and
a bushing fitted over each of the flanges, the pedal arm being coupled for rotational movement relative to the housing in a relationship wherein the flanges with bushings thereon extend into the recess in each of the respective walls and are supported on the shoulder in each of the respective walls.

6. The pedal assembly of claim 5 wherein at least one of the opposed walls of the housing defines an aperture and a bore extends through the drum and the flange, the pedal assembly further comprising a shaft extending through the bore and including an end extending through the aperture in the one of the opposed walls of the housing, the end of the shaft supporting a sensor arm.

7. The pedal assembly of claim 6 wherein the housing defines first and second cavities, the drum of the pedal arm extending into the first cavity and the sensor arm extending into the second cavity.

8. A pedal assembly for a vehicle comprising:
a housing including a wall; and
a pedal arm including a drum and a collar protruding outwardly from the drum, the collar extending and supported in the wall.

9. The pedal assembly of claim 8 wherein the housing includes first and second opposed side walls and a collar extends outwardly from each end of the drum into a recess defined in each of the first and second side walls respectively.

10. The pedal assembly of claim 9 wherein the recess in each of the side walls defines a shoulder, the collar being supported by the shoulder.

11. The pedal assembly of claim 10 wherein each of the side walls defines an aperture, a bore extends through the drum and each of the collars, and a shaft extends through the bore and includes opposed ends extending through the aperture in the respective side walls.
